(19) United States
(12) Patent Application Publication
(10) Pub. No.: US 2020/0182442 A1
(43) Pub. Date: Jun. 11, 2020

(54) Flexible Worklight

(71) Applicant: Kevin Huttenlocher, Myrtle Beach, SC (US)

(72) Inventor: Kevin Huttenlocher, Myrtle Beach, SC (US)

(21) Appl. No.: 16/708,359

(22) Filed: Dec. 9, 2019

Related U.S. Application Data
(60) Provisional application No. 62/777,238, filed on Dec. 10, 2018.

(51) Int. Cl. F21V 21/32; F21V 21/088; F21V 21/26; F21V 21/092; B60R 11/06

(52) U.S. Cl. CPC F21V 21/32; F21V 21/088; F21Y 2115/10; F21V 21/0925; B60R 11/06; F21V 21/26

(57) ABSTRACT

A worklight apparatus generally includes a conduit with a bendable body of sufficient rigidity to maintain the body in a fixed position and sufficient flexibility to reposition the body in a different fixed position. The apparatus includes an adjustable light means depending from one end and mounting means depending from an opposing end. The apparatus also includes a power supply for light means, wherein the power supply is coupled with light means via electrical wiring.

### I. RELATED APPLICATIONS

This application claims priority to U.S. Provisional Patent Application No. 62/777,238 filed on Dec. 10, 2018, the disclosure of which is hereby incorporated by reference in its entirety.

### II. FIELD OF THE INVENTION

This application discloses claims and embodiments generally related to a flexible worklight.

### III. BACKGROUND OF THE INVENTION

Numerous attempts have been made to improve lighting devices, including the following non-exhaustive description of some of those attempts:

U.S. Pat. No. 8,052,311 B2, issued in the name of Xhunga, discloses a lighting device mounted on reachable-by-hand vehicle ceilings or other low ceilings which includes a gooseneck;

U.S. Pat. No. 8,066,402 B2, issued in the name of Klipstein, discloses a work light which includes a hook for hanging the work light from automobile hoods or other elevated objects;

U.S. Pat. No. 6,540,184 B2, issued in the name of Thaxton, discloses an assembly to selectively hold, position and provide a stable platform in the form of legs for a light source;

U.S. Pat. No. 7,670,030 B2, issued in the name of Klipstein, discloses a lamp incorporated with reflectors for collecting light and shaping it into a beam;

U.S. Pat. No. 7,871,177 B1, issued in the name of Hanchett, discloses a light-mounting apparatus having a body including a leg extension and a bracket;

U.S. Pat. No. 5,521,806, issued in the name of Hutzel et al., discloses a light assembly having a casing or housing detachably retained on the hood of vehicle by a mounting bracket having a position-responsive switch interconnecting in series conductors;

U.S. Patent Publication No. 2007/0008719 A1, published in the name of Hill, discloses a hand-held retractable flashlight system having a flashlight with gripping means connected by a tether to a spool housing;

U.S. Pat. No. 8,517,560 B2, issued in the name of Murphy, discloses a portable multi-purpose illumination device having a holding and storage means, a positioning member that is extendable and manually deformable, a ball and socket assembly, and a power supply; and

U.S. Pat. No. 7,553,051 B2, issued in the name of Brass et al., discloses a work light having a handle with a light head that houses an LED heatsink.

Accordingly, there continues to be a need for improvements in hand-held light apparatuses and systems.

This application presents claims and embodiments that fulfill a need or needs not yet satisfied by the products, inventions and methods previously or presently available. In particular, the claims and embodiments disclosed herein describe a worklight apparatus, wherein the apparatus comprises a conduit comprising a bendable body of sufficient rigidity to maintain the body in a fixed position and sufficient flexibility to reposition the body in a different fixed position, the bendable body comprising a first terminus and a second terminus, the first terminus and the second terminus in mutual opposition; a light means depending from the first terminus; a mounting means depending from the second terminus, the mounting means configured for detachable coupling with a surface; and a power supply for the light means, wherein the apparatus of the present invention providing unanticipated and nonobvious combination of features distinguished from the products, devices, apparatuses, inventions and methods preexisting in the art. The applicant is unaware of any product, method, disclosure or reference that discloses the features of the claims and embodiments disclosed and taught herein.

### IV. SUMMARY OF THE INVENTION

In one embodiment, a worklight apparatus comprises a conduit comprising a bendable body of sufficient rigidity to maintain the body in a fixed position and sufficient flexibility to reposition the body in a different fixed position, the bendable body comprising a first terminus and a second terminus, the first terminus and the second terminus in mutual opposition, light means depending from the first terminus, mounting means depending from the second terminus, mounting means configured for detachable coupling with a surface, and, a power supply for light means, wherein the power supply is coupled with light means via electrical wiring.

In an aspect of the aforementioned embodiment, light means depends from the first terminus by pivot means adapted to pivot light means in a specific orientation. In such an embodiment, light means comprises a plurality of lights.

In another aspect of the aforementioned embodiment, mounting means comprises a suction mechanism comprising a suction plate, a lever and spring for deploying and releasing the suction plate, and a handle. In another embodiment, mounting means comprises vice-grip locking pliers. It is envisioned that the worklight apparatus further comprises a mounting adapter configured for threadedly engaging a threaded receiver.

In another embodiment, a worklight apparatus comprises a conduit comprising a bendable body of sufficient rigidity to maintain the body in a fixed position and sufficient flexibility to reposition the body in a different fixed position, the bendable body comprising a first terminus and a second terminus, the first terminus and the second terminus in mutual opposition, light means depending from the first terminus by pivot means adapted to pivot light means in a specific orientation, mounting means depending from the second terminus, mounting means configured for detachable coupling with a surface, mounting means comprising a suction mechanism comprising a suction plate, a lever and spring for deploying and releasing the suction plate, and a handle, and, a power supply for light means, wherein the power supply is coupled with light means via electrical wiring.

In one aspect of the aforementioned embodiment, light means comprises a single bulb. In another aspect, light means comprises a plurality of bulbs. In another aspect, light means comprises a single light emitting diode (LED) in the form of a linearly-elongated array. In another aspect, light means comprises a plurality of light emitting diodes (LEDs) in the form of a linearly-elongated array.

In another aspect of the aforementioned embodiment, the power supply comprises an external power source. It is envisioned that the external power source comprises an electrical connector device adapted to supply 12-volt direct current to light means. It is also envisioned that the electrical connector device comprises a 12-volt direct current male plug. It is also envisioned that the electrical connector device comprises a 12-volt direct current battery cables at one end thereof and a female plug receiver at an opposing end for mating with the male plug.

In another embodiment, a worklight apparatus comprises a conduit comprising a bendable body of sufficient rigidity to maintain the body in a fixed position and sufficient flexibility to reposition the body in a different fixed position, the bendable body comprising a first terminus and a second terminus, the first terminus and the second terminus in mutual opposition, light means depending from the first terminus, mounting assembly comprising mounting means and a mounting adapter, the mounting assembly disposed at the second terminus, wherein mounting means is configured for detachable coupling with a surface, mounting means comprising a vice-grip locking pliers, and the mounting adapter configured for threadedly engaging a threaded receiver, and, a power supply for light means, wherein the power supply is coupled with light means via electrical wiring.

In one aspect of the aforementioned embodiment, light means comprises a single bulb. In another aspect, light means comprises a plurality of bulbs. In another aspect, light means comprises a single light emitting diode (LED) in the form of a linearly-elongated array. In another aspect, light means comprises a plurality of light emitting diodes (LEDs) in the form of a linearly-elongated array.

In another aspect of the aforementioned embodiment, the power supply comprises an external power source. It is envisioned that the external power source comprises an electrical connector device adapted to supply 12-volt direct current to light means. It is also envisioned that the electrical connector device comprises a 12-volt direct current male plug. It is also envisioned that the electrical connector device comprises a 12-volt direct current battery cables at one end thereof and a female plug receiver at an opposing end for mating with the male plug.

In another aspect of the aforementioned embodiment, the mounting adapter comprises a linearly elongated body with external threads that mate with internal threads of a threaded receiver provided within the workspace or workarea. The pliers would be utilized to rotate the mounting adapter along the proper rotational routing (clockwise or counterclockwise) to properly advance or remove the adapter within the threaded receiver, thereby securing and/or removing the adapter relative to the threaded receiver.

### V. BRIEF DESCRIPTION OF THE DRAWING(S)

The advantages and features of the present invention will become better understood with reference to the following more detailed description and claims taken in conjunction with the accompanying drawings, in which like elements are identified with like symbols, and in which:

FIG. 1 is a perspective view of one embodiment of a worklight apparatus having mounting means in form of a suction mechanism and with a single-bulb light array;

FIG. 2 is a perspective view of light means comprising a single-bulb light array;

FIG. 3 is a perspective view of mounting means comprising a suction mechanism and with power supply partially depicted;

FIG. 4 is a perspective view of the worklight apparatus comprising light means having a multi-bulb light array and mounting means comprising pliers and mounting adapter;

FIG. 5 is a perspective view of the worklight apparatus comprising a male-plug and female-receiver with a 12-volt alligator clip connector with a battery;

FIG. 6 is a perspective view of a plurality of embodiments of the mounting adapter, depicted multiple diameter sizes; and

FIGS. 7A-7D illustrate an exemplary external power source, in accordance with another embodiment of the present invention.

### VI. DETAILED DESCRIPTION OF THE EMBODIMENT(S)

It will be readily understood that the components of the present invention, as generally described and illustrated in the figures herein, may be arranged and designed in a wide variety of different configurations. Thus, the following detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

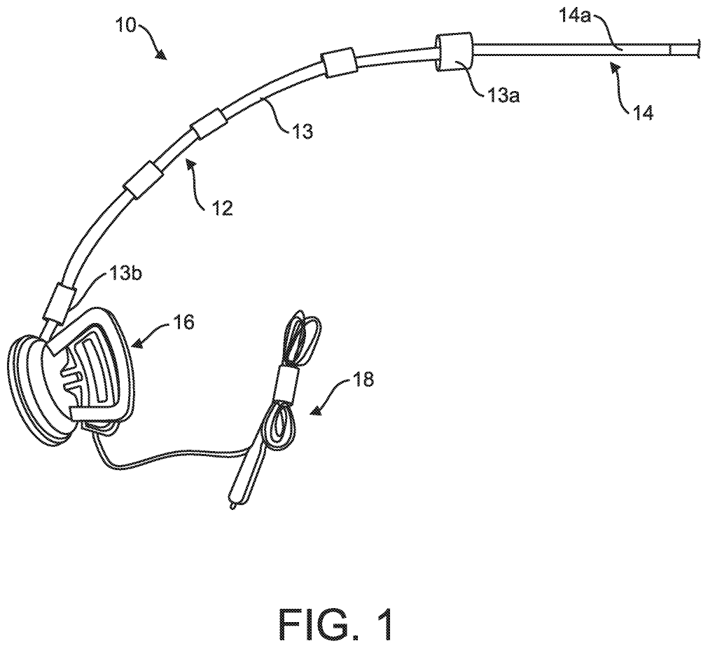

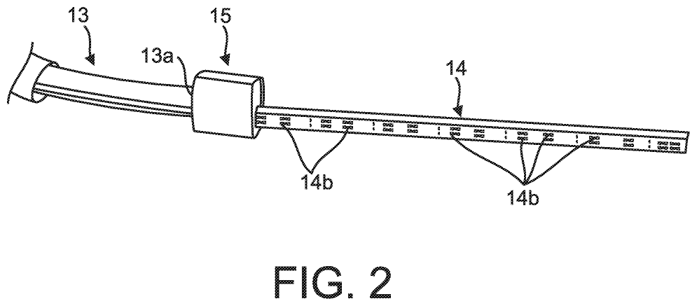

Referring now to FIG. 1 through FIG. 6, a worklight apparatus 10 comprises a conduit 12 comprising a bendable body 13. The bendable body 13 comprising a first terminus 13a and a second terminus 13b, with the first terminus 13a and the second terminus 13b in mutual opposition. The conduit 12 and body 13 also include light means 14 depending from the first terminus 13a. The conduit 12 and body 13 also include mounting means 16 depending from the second terminus 13b, with mounting means 16 configured for detachable coupling with a surface. The apparatus 10 further includes a power supply 18 for light means 14, wherein the power supply 18 is coupled with light means 14 via electrical wiring 20.

The conduit 12 and bendable body 13 comprises a gooseneck configuration and may comprise a variety of materials and/or material combinations. The body 13 of conduit 12 comprises material and/or material combinations of sufficient rigidity to maintain the body in a fixed position and sufficient flexibility to reposition the body in a different fixed position. The body 13 of conduit 12 is preferably made from material having desirable durability and longevity, capable of withstanding considerable alternative configurations.

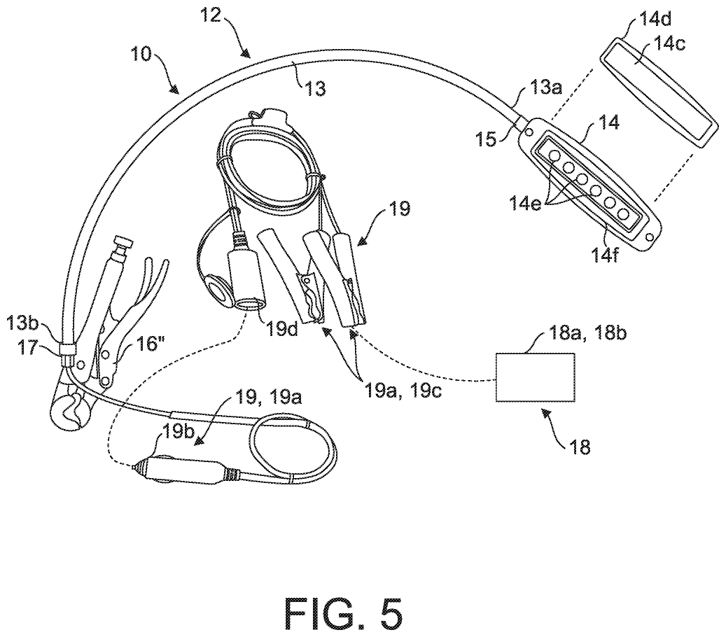

Light means 14 may comprise multiple variations and embodiments. For example, light means 14 may depend from the first terminus 13a by pivot means 15 adapted to pivot light means 14 in a specific orientation. In particular, it is envisioned that pivot means 15 may articulate through 360 degrees of rotation and is adapted and configured for positioning in multiple fixed points along the 360 degrees of rotation. Even more particular, it is envisioned that pivot means 15 is adapted and configured for positioning approximately every 30 degrees of rotation, whether clockwise or counterclockwise in reference. In another example of an alternate embodiment, light means 14 comprises a single bulb 14a. In another aspect, light means 14 comprises a plurality of bulbs 14b. In another aspect, light means comprises a single light emitting diode (LED) 14c in the form of a linearly-elongated array 14d (depicted in FIG. 5 as an alternative to 14e and 14f described below). In another aspect, light means 14 comprises a plurality of light emitting diodes (LEDs) 14e in the form of a linearly-elongated array 14f.

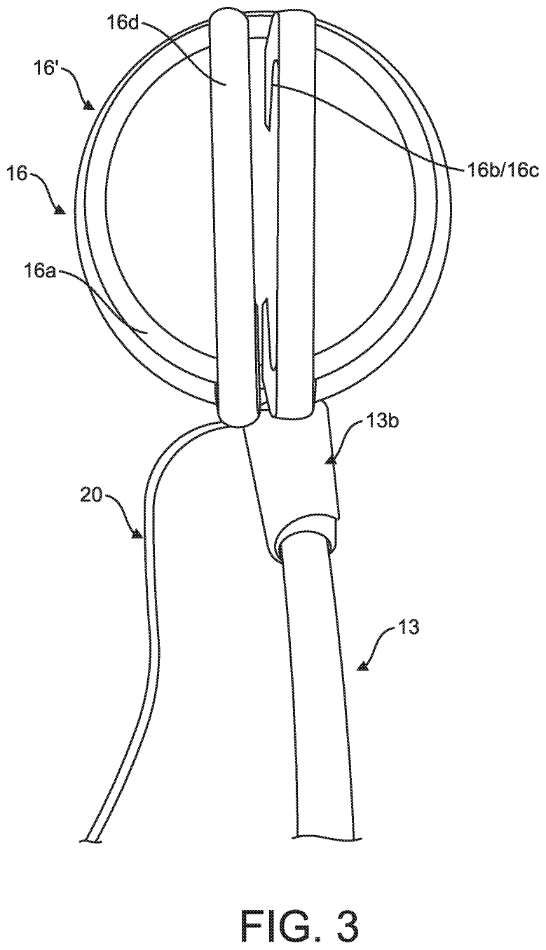

Mounting means 16 may comprise multiple variations and embodiments. For example, consistent with FIG. 1 and FIG. 3, mounting means 16 comprises a suction mechanism 16′ comprising a suction plate 16a, a lever 16b and spring 16c for deploying and releasing the suction plate 16a, and a handle 16d.

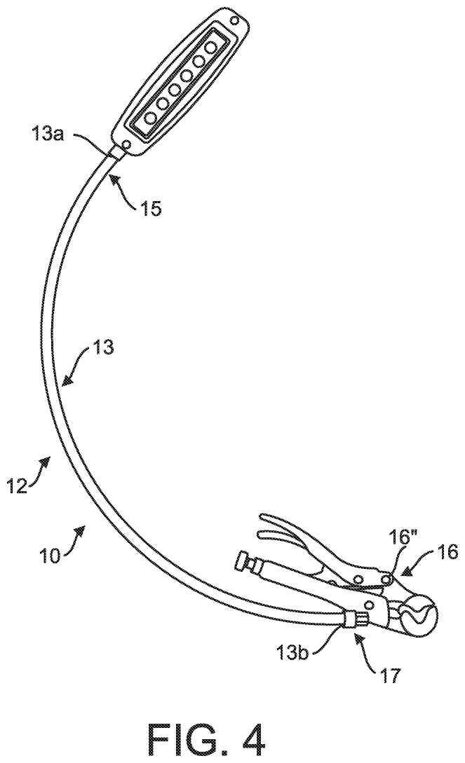

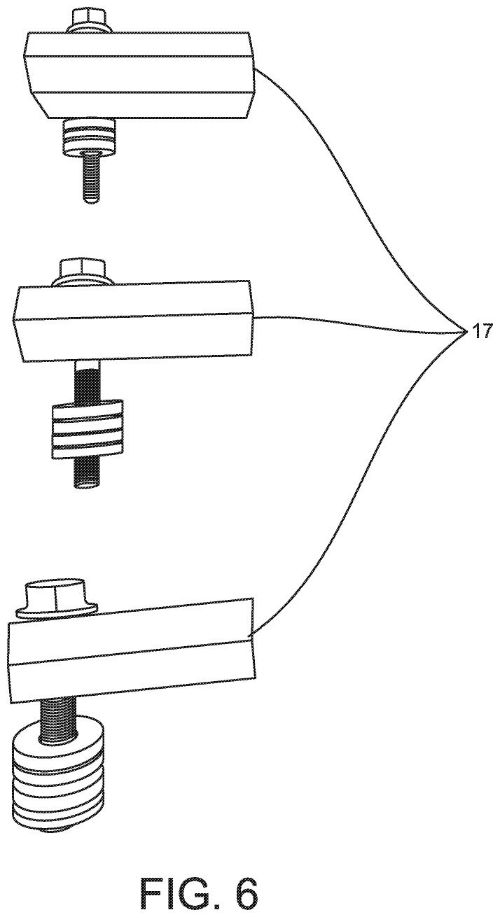

In another embodiment, and consistent with FIG. 4, FIG. 5, and FIG. 6, mounting means 16 comprises vice-grip locking pliers 16″. It is envisioned that the worklight apparatus 10 further comprises a mounting adapter 17 configured for threadedly engaging a threaded receiver, the mounting means 16 and mounting adapter 17 provided in combination to cooperatively secure the worklight apparatus 10 to an identified location within a workspace or workarea. In another embodiment, the reverse configuration is envisioned, with the mounting adapter 17 secured at or near the workarea or workspace surface and the threaded receiver formed at the second terminus 13b of body 13 of conduit 12. Regardless of configuration or orientation, and in one embodiment, the pliers 16″ engages the mounting adapter 17 or threaded receiver formed at the second terminus 13b for rotation of the adapter 17 or receiver to tighten or loosen the threaded mating or coupling between the adapter 17 and a threaded receiver provided at the workspace or workarea.

The mounting adapter 17 may comprise a variety of embodiments and combinations. For example, consistent with FIG. 6, it is envisioned that the mounting adapter 17 comprises a linearly elongated body with external threads that mate with internal threads of a threaded receiver provided within the workspace or workarea. The pliers 16″ would be utilized to rotate the mounting adapter 17 along the proper rotational routing (clockwise or counterclockwise) to properly advance or remove the adapter 17 within the threaded receiver, thereby securing and/or removing the adapter 17 relative to the threaded receiver.

The power supply 18 comprises an external power source 19 supplying a form of usable energy to the apparatus 10 and its light means 14. It is envisioned that the external power supply 19 can take multiple forms and combinations, including standard delivery of electricity through outlets and insertable/removable electrical cords, batteries, capacitors, solar panel collection and translation to the apparatus (including through batteries and/or capacitors), and other similar and/or known mechanisms. In particular, it is envisioned that the external power source 19 comprises an electrical connector device 19a adapted to supply 12-volt direct current to the light means 14. It is also envisioned that the electrical connector device 19a comprises a 12-volt direct current male plug 19b adapted for slidably fitting in a motor vehicle cigarette lighter socket (not shown), thereby being suitable to receive power from a direct current source, preferably a 12-volt direct current source 18a, such as a motor vehicle battery 18b. It is also envisioned that the electrical connector device 19a comprises a 12-volt direct current battery cables 19c at one end thereof and a female plug receiver 19d at an opposing end for mating with the male plug 19b. The battery cables 19c connect directly to a direct current source, such as a 12-volt direct current, motor vehicle battery 18b. The power supply 18 delivers energy through one or more electrical wires 20 that interconnects and providing electrical interoperability between the power supply 18 and the light means 14.

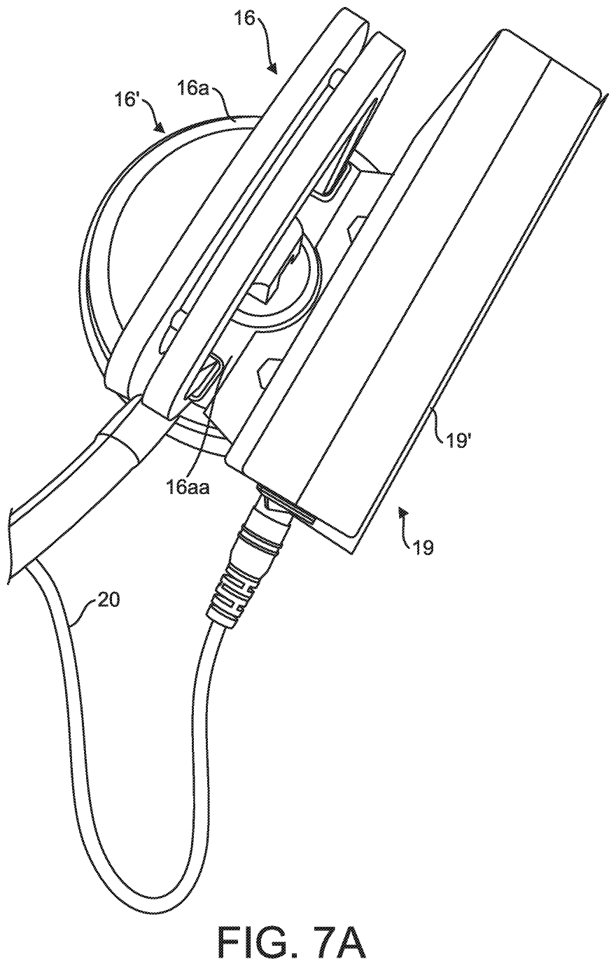

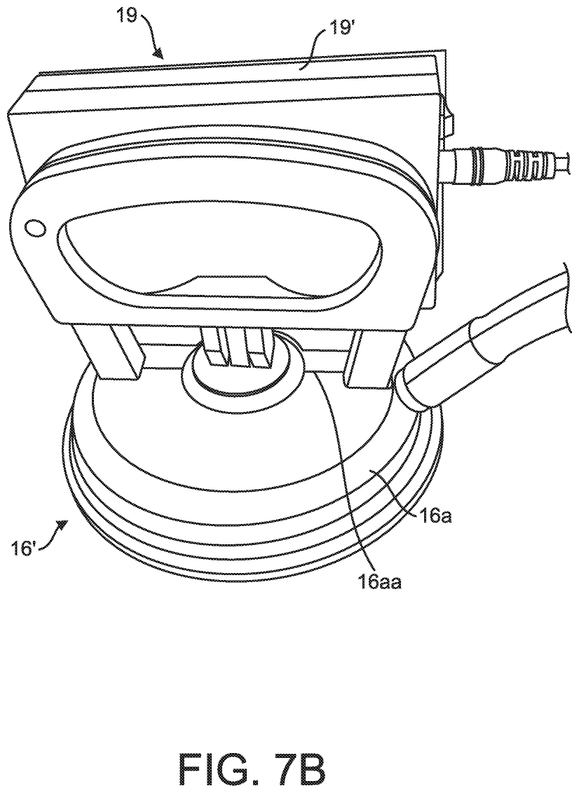

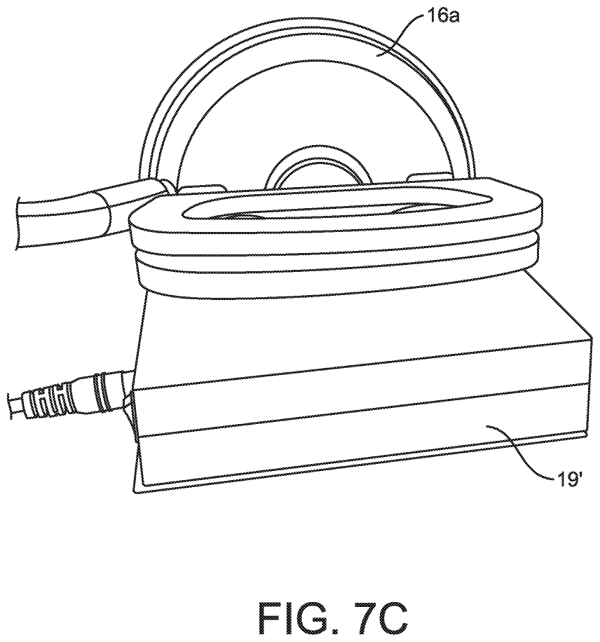

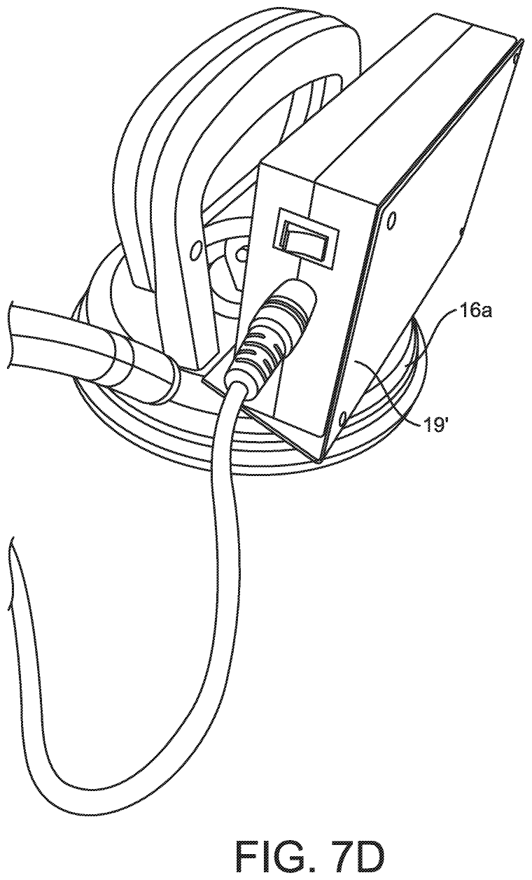

Finally, in reference to FIGS. 7A-7D, an alternate embodiment is provided wherein the external power source 19 is a rechargeable 12-volt battery 19′ mounted to the mounting means 16, depicted herein as the suction plate 16a. In accordance to one exemplary embodiment, the rechargeable battery 19′ may be mounted to an upper surface 16aa of the suction plate 16a.

It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

What is claimed is:

1. A worklight apparatus comprising:
a conduit comprising a bendable body of sufficient rigidity to maintain the body in a fixed position and sufficient flexibility to reposition the body in a different fixed position, the bendable body comprising a first terminus and a second terminus, the first terminus and the second terminus in mutual opposition;
a light means depending from the first terminus;
a mounting means depending from the second terminus, the mounting means configured for detachable coupling with a surface; and
a power supply for light means, wherein the power supply is coupled with light means via electrical wiring.

2. The worklight apparatus of claim 1, wherein the light means depends from the first terminus by a pivot means adapted to pivot the light means in a specific orientation.

3. The worklight apparatus of claim 2, wherein the light means comprises a plurality of lights.

4. The worklight apparatus of claim 1, wherein the mounting means comprises a suction mechanism comprising:
a suction plate;
a handle;
a lever; and
a spring for deploying and releasing the suction plate.

5. The worklight apparatus of claim 1, wherein the mounting means comprises a vice-grip locking pliers.

6. The worklight apparatus of claim 5 further comprising a mounting adapter configured for threadedly engaging a threaded receiver.

7. A worklight apparatus comprising:
a conduit comprising a bendable body of sufficient rigidity to maintain the body in a fixed position and sufficient flexibility to reposition the body in a different fixed position, the bendable body comprising a first terminus and a second terminus, the first terminus and the second terminus in mutual opposition;
a light means depending from the first terminus by pivot means adapted to pivot light means in a specific orientation;
a mounting means depending from the second terminus, mounting means configured for detachable coupling with a surface, mounting means comprising a suction mechanism comprising a suction plate, a lever and spring for deploying and releasing the suction plate, and a handle; and
a power supply for light means, wherein the power supply is coupled with light means via electrical wiring.

8. The worklight apparatus of claim 7, wherein the light means comprising a single bulb.

9. The worklight apparatus of claim 7, wherein the light means comprising a plurality of bulbs.

10. The worklight apparatus of claim 7, wherein the light means comprises a single light emitting diode (LED) in the form of a linearly-elongated array.

11. The worklight apparatus of claim 7, wherein the light means comprises a plurality of light emitting diodes (LEDs) in the form of a linearly-elongated array.

12. The worklight apparatus of claim 7, wherein the power supply comprises an external power source.

13. The worklight apparatus of claim 7, wherein the external power source comprises an electrical connector device adapted to supply 12-volt direct current to the light means.

14. The worklight apparatus of claim 7, wherein the electrical connector device comprises a 12-volt direct current male plug.

15. The worklight apparatus of claim 7, wherein the electrical connector device comprises a 12-volt direct current battery cables at one end thereof and a female plug receiver at an opposing end for mating with the male plug.

16. A worklight apparatus comprising:
a conduit comprising a bendable body of sufficient rigidity to maintain the body in a fixed position and sufficient flexibility to reposition the body in a different fixed position, the body comprising a first terminus and a second terminus, the first terminus and the second terminus in mutual opposition;
a light means depending from the first terminus;
a mounting assembly comprising a mounting means and a mounting adapter, the mounting assembly disposed at the second terminus, wherein the mounting means is configured for detachable coupling with a surface, the mounting means comprising a vice-grip locking pliers, and the mounting adapter configured for threadedly engaging a threaded receiver; and
a power supply for the light means, wherein the power supply is coupled with the light means via electrical wiring.

17. The worklight apparatus of claim 16, wherein the light means comprises at least one bulb.

18. The worklight apparatus of claim 16, wherein the light means comprises at least one light emitting diode (LED).

19. The worklight apparatus of claim 16, wherein the mounting adapter comprises a threaded adapter and a threaded receiver, the threaded adapter and threaded receiver threadably and cooperatively mated for securing the apparatus within a workspace.

20. The worklight apparatus of claim 16, wherein the power supply provides electrical energy from an external source, the external power source comprises an electrical connector device adapted to supply 12-volt direct current to the light means.
